(19) United States
(12) Patent Application Publication
(10) Pub. No.: US 2026/0346571 A1
(43) Pub. Date: Nov. 5, 2026

(54) MULTILAYER PACKAGING, GRAPHENE FILM, GRAPHENE OXIDE FILM AND THEIR METHODS OF MANUFACTURING

(71) Applicant: Toraphene Ltd, Exmouth (GB)

(72) Inventors: Lijie He, Exmouth (GB); Gaute Juliussen, Exmouth (GB)

(21) Appl. No.: 19/118,854

(22) PCT Filed: Oct. 6, 2023
(86) PCT No.: PCT/IB2023/060049

§ 371 Date: Apr. 7, 2025

(30) Foreign Application Priority Data
Oct. 7, 2022 (GB) 2214802.7

(51) Int. Cl. B32B 9/00; B32B 37/24

(52) U.S. Cl. CPC B32B 9/007; B32B 37/24; B32B 2037/243; B32B 2307/7265; B32B 2307/7376

(57) ABSTRACT

Disclosed is a multi-layer packaging comprising a plurality of layers of packaging materials, wherein one or more layers amongst the plurality of layers comprise a film comprising at least one of: graphene or graphene oxide, and wherein the multi-layer packaging is impermeable to moisture or fluids.

### TECHNICAL FIELD

The present invention relates to multi-layer packaging. In particular, though not exclusively, this invention relates to a multi-layer packaging comprising graphene film and graphene oxide film. The present invention also relates to a method of manufacturing a multi-layer packaging, graphene film and graphene oxide film.

### BACKGROUND

Graphene has been widely used for various applications in different industries. Owing to its unique physiochemical properties, the graphene has been increasingly used in biomedical devices, composites and coatings, electronic devices, sensors, membranes, packaging, or the similar. The properties may include, enhanced mechanical strength, electrical conductivity, thermal conductivity, or the like.

In packaging industry, the graphene may be used in a form of graphene film and/or graphene oxide film with large surface area. Packaging is one of utmost importance in product's development. Apart from its primary role of containing, the packaging also protects products from physical, chemical, and biological contamination. Therefore, it is almost impossible for a single layer structure to fulfil all the requirements. Therefore, multi-layer structures have been used which combine unique functionalities of several layers, possess superior properties as compared to the single layer structure in terms of mechanical properties, barrier properties and functional properties. Therefore, there is an increasing demand for multi-layer structures for packaging. it is estimated that multi-layer structures account for 26% of packaging of market by weight.

Conventionally, multi-layer structure may include barrier films made of metal foils, notably, a lamination of pure aluminium layer (99.5%) or its alloy. However, there are certain problems associated with metal foils as they are considered environmentally unfriendly and/or may have high energy consumption during production. Often, adhesives or an adhesive layer are added between barrier films and other layers to ensure bonding of various layers of the multi-layer structure. This may increase difficulties in recycling of the multi-layer structure. The recycling process of the multi-layer structures turned out to be challenging as identification, sorting and separation of various layers may be different. As a result, the multi-layer structure is sorted as a mixed plastic waste and subjected to incineration.

However, in an attempt to mitigate aforesaid problem of packaging, the graphene film and graphene oxide film can be used as the barrier layer. However, the conventional graphene film and the graphene oxide film may be of poor quality in term of porosity, uniformity, and the like. For example, the conventional graphene film and the graphene oxide may be highly porous resulting in permeability by fluids. Further, the conventional graphene film and the graphene oxide film has defects such as grain boundaries, point defects, or the similar. Hence, conventional graphene film and the graphene oxide films often exhibit less attractive barrier properties in packaging.

The aforesaid limitations of the conventional graphene film and the graphene oxide film may be due to processes involved in manufacturing of the same. For example, the graphene film can be produced by various processes, such as chemical vapour deposition (CVD), dip-coating, spray-coating, bar-coating. However, these methods have several problems associated with them. For example, the CVD is costly, and may often result in production of defects and/or grain boundaries in the graphene film. Further, the aforesaid methods may lead to contamination during transfer. Moreover, the aforesaid processes of dip-coating, spray-coating, bar-coating for production of the graphene film largely depends on evaporation process of a solvent used.

Therefore, in light of the foregoing discussion, there exists a need to overcome the aforementioned drawbacks associated with the graphene film and the graphene oxide film and their methods of manufacturing.

### SUMMARY OF THE INVENTION

A first aspect of the invention provides a multi-layer packaging comprising a plurality of layers of packaging materials, wherein one or more layers amongst the plurality of layers comprise a film comprising at least one of: graphene or graphene oxide, and wherein the multi-layer packaging is impermeable to moisture or fluids.

In this regard, optionally, a number of the plurality of layers lie in a range of 3 layers to 12 layers. The number of the plurality layers lie in a range of 3 layers to 5 layers, 3 layers to 9 layers, 3 layers to 12 layers, 5 layers to 9 layers, 5 layers to 12 layers, 8 layers to 12 layers. Notably, the one or more layers amongst the plurality of layers may be made of the graphene or the graphene oxide. In an example, two layers amongst the plurality of layers may be made of the graphene. In another example, three layers amongst the plurality of layers may be made of the graphene oxide. Optionally, the one or more layers are made of the graphene and the graphene oxide. Notably, the impermeability to the moisture or the fluids is imparted to the multi-layer packaging owing to presence of the one or more layers made of the graphene or the graphene oxide.

Optionally, the multi-layer packaging may be at least one of: a flexible packaging, a semi-rigid packaging. Examples of the flexible packaging may include, but are not limited to, sachets, packaging of soaps, packaging of personal hygiene products, packaging of health supplements such as pain relief, respiratory, oral, vitamins/minerals, and digestive health, packaging of condiments, packaging of medicines, pouches, crisp bags. Examples of the semi-rigid packaging may include food and beverage cartons. Optionally, layer(s) of the multi-layer packaging is made of a polymer. The polymer could be selected from at least one of: Polyethylene (PE), Polydimethylsiloxane (PDMS), polyvinyl alcohol (PVA), Poly(methyl methacrylate) (PMMA), Polypropylene (PP), Polyhydroxyalkanoate (PHA), Polybutylene succinate (PBS), Polylactic acid (PLA), Polybutylene terephthalate (PBT).

Optionally, the film comprises at least one layer of graphene, wherein the film has a first thickness in a range of 0.5 μm to 10 μm, and wherein the film is impermeable to moisture or fluids. For sake of simplicity, the film comprising the at least one layer of graphene is referred to as “graphene film” in the description.

In this regard, the term “layer of graphene” refers to a structure formed by hexagonal rings of sp²bonded carbon atoms. The carbon atoms are tightly packed into a two-dimensional honeycomb lattice in the at least one layer of graphene. Optionally, the at least one layer of graphene is defect free. The term “defect” refers to structural defects present in the at least one layer of graphene. The structural defects may include, but are not limited to, Stone-Wales defects, vacancies, Adatoms and substitutions, dislocations, grain boundaries. Optionally, absence of the structural defects imparts impermeability to the graphene film. In one implementation, the graphene film includes a number of layers of the graphene. Optionally, the number of layers of the graphene are densely packed with each other. Optionally, a densely packed assembly of the layers of the graphene may impart enhanced impermeability to the graphene film. Optionally, a number of layers of the graphene in the graphene film may impact the first thickness of the graphene film. For example, a large number of layers of the graphene, more is the first thickness of the graphene film.

Notably, the first thickness lies in a range of 0.5 micrometre (μm) to 10 μm. The first thickness lies in a range of 0.5 μm to 2 μm, 0.5 μm to 5 μm, 0.5 μm to 8 μm, 0.5 μm to 10 μm, 1 μm to 5 μm, 1 μm to 8 μm, 1 μm to 10 μm, 3 μm to 8 μm, 3 μm to 10 μm, 5 μm to 10 μm. Optionally, the first thickness of the graphene film depends upon first volume of an exfoliated stabilized graphene solution passed through at least one first filter membrane as described in below paragraphs. Optionally, the graphene film is used for varying applications depending upon the first thickness of the graphene film. As an example, the graphene film having the first thickness of 300 nanometre (nm) may be used as a barrier film in packaging. As another example, graphene film having the first thickness of 1000 nm may be used as a coating. It will be appreciated that other applications of the graphene film are well within the scope of the present invention.

The graphene film is a film having enhanced flexibility, strength, high barrier property, thermal stability and chemical stability. The graphene film is highly impermeable to moisture, aroma, light, fluids, and the like. High impermeability of the graphene film makes it suitable to be used for various application in different industries such as, food industry, medical industry, chemical industry, electronic industry, packaging industry, and the like. Beneficially, the graphene film is an alternative to metal foils used as a barrier film in different types of packaging. Utilization of the graphene film is environmentally friendly as it requires limited energy resources for its production and/or can be recycled with ease.

Optionally, when the multi-layer packaging is subjected to a recycling process, the graphene film comprising the at least one layer of graphene provides self-recyclable properties to the multi-layer packaging.

In this regard, the film comprising the at least one layer of the graphene gets combined with other layer(s) of the multi-layer packaging by covalent and/or non-covalent bond. Herein, the term “other layer(s)” encompass layer(s) of the multi-layer packaging other than the one or more layers comprising a film comprising at least one of: the graphene or the graphene oxide. Optionally, the film binds with the other layer(s) of the multi-layer packaging through Van der Waals force. Optionally, the polymer having pi (π) bond can bind with the graphene film through a chemical bond resulting from π-π interaction. Optionally, the graphene film is used as an additive within layers of the multi-layer packaging for imparting enhanced mechanical, thermal, electrical properties to the multi-layer packaging. Optionally, the graphene film within the multi-layer packaging acts as an enhancement filler and/or compatibilizer for later on primary or secondary recycling. Advantageously, the technical effect of the graphene film in the multi-layer packaging is that, during recycling of the multi-layer packaging, the one or more layers of the graphene film need not to be separated from the multi-layer packaging. The multi-layer packaging can be self-recycled with ease.

Optionally, the film comprises at least one layer of graphene oxide, wherein the film comprising the at least one layer of graphene oxide has a second thickness in a range of 0.5 um to 20 um, and wherein the film is impermeable to moisture or fluids. For sake of simplicity, the film comprising the at least one layer of graphene oxide is referred to as “graphene oxide film” in the description.

In this regard, “layer of graphene oxide” refers to a structure formed by hexagonal rings of sp² bonded carbon atoms and various oxygen containing functional groups. The carbon atoms are tightly packed into a two-dimensional honeycomb lattice in the at least one layer of graphene oxide. The functional groups may include epoxides, hydroxyl groups and carboxyl groups. The functional groups are present on surface of the two-dimensional honeycomb lattice. Optionally, the at least one layer of graphene oxide is substantially defect free. Optionally, absence of structural defects imparts impermeability to the graphene oxide film. In one implementation, the graphene oxide film includes a number of layers of the graphene oxide. Optionally, the number of layers of the graphene oxide are densely packed with each other. Optionally, the number of layers of the graphene oxide has enhanced material homogeneity and interlayer binding, resulting in densely packed assembly of layers. Optionally, a densely packed assembly of layers of the graphene oxide may impart enhanced impermeability to the graphene oxide film. Optionally, a number of layers of the graphene oxide in the graphene oxide film may impact the second thickness of the graphene oxide film. For example, a large number of layers of the graphene oxide, more is the second thickness of the graphene oxide film.

Notably, the second thickness lies in a range of 0.5 μm to 20 μm. The second thickness lies in a range of 0.5 μm to 6 μm, 0.5 μm to 10 μm, 0.5 μm to 14 μm, 0.5 μm to 20 μm, 2 μm to 10 μm, 2 μm to 14 μm, 2 μm to 17 μm, 2 μm to 20 μm, 5 μm to 10 μm, 5 μm to 14 μm, 5 μm to 17 μm, 5 μm to 20 μm, 8 μm to 14 μm, 8 μm to 17 μm, 8 μm to 20 μm, 12 μm to 20 μm. optionally, the second thickness of the graphene oxide film depends upon volume of an exfoliated stabilized graphene oxide solution being passed through at least one second filter membrane as described in below paragraphs. Optionally, the graphene oxide film is used for varying applications depending upon the second thickness of the graphene oxide film. For example, the graphene oxide film having the second thickness of 550 nm may be used as the barrier film in packaging. It will be appreciated that other applications of the graphene oxide film are well within the scope of the present invention.

The graphene oxide film has enhanced flexibility, strength, high barrier property, thermal stability and chemical stability. The graphene film is highly impermeable to moisture, aroma, light, fluids, and the like. Optionally, the fluids are at liquids and/or gases. High impermeability of the graphene oxide film makes it suitable to be used for various application in different industries such as, food industry, medical industry, chemical industry, electronic industry, and the like. Optionally, the fluids include at least one of: gases, liquids. Utilization of the graphene film is environmentally friendly as it requires limited energy resources for its production and can be recycled with ease.

Optionally, when the multi-layer packaging is subjected to a recycling process, the film comprising the at least one layer of graphene oxide provides self-recyclable properties to the multi-layer packaging. In this regard, owing to the presence of the oxygen containing functional groups on the at least one layer of the graphene oxide, the graphene oxide film forms a plurality of chemical bonds with the other layer(s) of the multi-layer packaging. The oxygen containing functional groups may be positively charged or negatively charged. Optionally, the positively charge and the negatively charged oxygen containing functional groups can electrostatically interact with the other layer(s). Optionally, the graphene oxide film is used as an additive within layers of the multi-layer packaging for imparting enhanced mechanical, thermal, electrical properties to the multi-layer packaging. Optionally, the graphene oxide film is incorporated within the multi-layer packaging as an enhancement filler and/or compatibilizer. Optionally, the film is added by a continuous process with the other layer(s) of the multi-layer packaging applied to its substrate using at least one of: roll-to-roll, adhesive lamination, thermal lamination, liquid lamination, additive manufacturing, three-dimensional (3D) printing. Advantageously, the technical effect of incorporating the graphene oxide film in the multi-layer packaging is that the during recycling of the multi-layer packaging, the one or more layers of the graphene oxide film need not to be separated from the multi-layer packaging. The multi-layer packaging can be self-recycled with ease.

The multi-layer packaging of the present invention has enhanced strength and excellent barrier properties. The Multi-packaging can be effectively used in a variety of packaging owing to its impermeability to the moisture or gases. For example, the multi-layer packaging may be effectively used in soft packaging. Further, the plurality of layers of the multi-layer packaging can be easily bonded together eliminating the need of adhesive lamination which significantly reduces time taken to manufacture the multi-layer packaging. Further, the multi-layer packaging is environmentally friendly as it can be easily recycled and/or requires limited energy resources during manufacturing.

A second aspect of the present invention provides a method of manufacturing a multi-layer packaging, the method comprising:
manufacturing each of a plurality of layers of packaging materials that constitute the multi-layer packaging, wherein one or more layers amongst the plurality of layers comprise a film comprising at least one of: graphene or graphene oxide, and wherein the film is impermeable to moisture or fluids; and
assembling the plurality of layers in a required manner to form the multi-layer packaging.

In this regard, the manufacturing of the each of the plurality of layers depends upon the type of the multi-layer packaging. A raw material used for manufacturing the plurality of layers may depend upon usability of the multi-layer packaging. In an example, multi-layer packaging used for crisps and other dry products may be made of paper. In another example, the multi-layer packaging for the food and beverage may be made of leak proof material. It will be appreciated that, a method of manufacturing the film comprising the at least one of: graphene or graphene oxide is described in third and fourth aspect below. Optionally, the plurality of layers is assembled by at least one of: a machine with a robotic arm, a robot, hands of a person. Assembling of the plurality of layers is well known in the art.

A third aspect of the invention provides method of manufacturing a film comprising graphene, the method comprising:
dispersing the graphene in an organic solvent for preparing a graphene solution;
adding a stabilizer in the graphene solution for obtaining a stabilized graphene solution;
sonicating the stabilized graphene solution for a first time duration for preparing an exfoliated stabilized graphene solution; and
filtering the exfoliated stabilized graphene solution for obtaining the film on a first surface, wherein the film has a first thickness in a range of 0.5 μm to 10 μm, and wherein the film comprises at least one layer of the graphene.

In this regard, a required amount of the graphene is dispersed in the organic solvent. The required amount of the graphene could lie in a range of 1 gram (gm) to 10 gm, depending on the final concentrations and volume of the resulted solution. The required amount of the graphene lies in a range of 1 gm to 4 gm, 1 gm to 6 gm, 1 gm to 8 gm, 1 gm to 10 gm, 2 gm to 6 gm, 2 gm to 8 gm, 2 gm to 10 gm, 3.5 gm to 6 gm, 3.5 gm to 8 gm, 3.5 gm to 10 gm, 5 gm to 8 gm, 5 gm to 10 gm. Optionally, the organic solvent is one of: Toluene, Cyrene, ethyl acetate, Dimethylformamide (DMF), N-Methylpyrrolidone (NMP). Optionally, concentration of the graphene solution lies in a range of 0.5 mg/ml-2 mg/ml. Optionally, the step of dispersion of the graphene in the organic solvent is performed by sonication. Optionally, the step of sonication may be performed for a time duration lying in a range of 20 hours-40 hours. The time duration lies in a range of 20 hours to 27 hours, 20 hours to 35 hours, 20 hours to 38 hours, 20 hours to 40 hours, 22 hours to 38 hours, 22 hours to 40 hours, 25 hours to 35 hours, 25 hours to 38 hours, 25 hours to 40 hours, 30 hours to 38 hours, 30 hours to 40 hours.

Optionally, the stabilizer could be at least one of: a low molecular weight surfactant, a biopolymer. Examples of the low molecular weight surfactant could be Cetyltrimethyl ammonium bromide (CTAB) sodium dodecyl sulfate (SDS), and the like. Examples of the biopolymer could be nanocellulose, ethyl cellulose, and the like. Optionally, the stabilizer having a pre-defined concentration is pre-dissolved in a solvent. Examples of the solvent include, but are not limited to, ethanol, toluene. Optionally, the stabilizer is dissolved in the solvent in a ratio of 20:80, respectively. In an example, the ethyl cellulose having a concentration of 2 mg/ml may be dissolved in a mixture of ethanol and toluene. Next, a required amount of the stabilizer may be added to the graphene solution. Optionally, the required amount of the stabilizer depends upon the required amount of the graphene in the graphene solution. Optionally, the required amount of the stabilizer lies in a range of 2 percent to 20 percent weight of the graphene. The required amount of the graphene lies in a range of 2 percent to 7 percent, 2 percent to 12 percent, 2 percent to 2 percent to 16 percent, 2 percent to 18 percent, 2 percent to 20 percent, 5 percent to 12 percent, 5 percent to 16 percent, 5 percent to 18 percent, 5 percent to 20 percent, 9 percent to 12 percent, 9 percent to 16 percent, 9 percent to 20 percent, 13 percent to 18 percent, 13 percent to 20 percent. Optionally, the step of adding the stabilizer in the graphene solution is performed at room temperature.

Optionally, the first-time duration lies in a range of 10 minutes to 2 hours in sonication. The first time duration lies in a range of 10 minutes to 40 minutes, 10 minutes to 80 minutes, 10 minutes to 100 minutes, 10 minutes to 2 hours, 15 minutes to 80 minutes, 15 minutes to 100 minutes, 15 minutes to 2 hours, 30 minutes to 80 minutes, 30 minutes to 2 hours, 50 minutes to 100 minutes, 50 minutes to 2 hours, 80 minutes to 2 hours. In an example, the stabilized graphene solution may be sonicated for 1 hour. Optionally, the step of sonication is performed to exfoliate the stabilized graphene solution. Optionally, the step of sonication is performed using one of: a probe sonicator or bath sonicator. Optionally, the step of sonication is performed at the room temperature.

Optionally, the step of filtering the exfoliated stabilized graphene solution is performed using at least one first filter membrane, the first surface being a surface of the at least one first filter membrane, and wherein the first volume of the exfoliated stabilized graphene solution is passed through the at least one first filter membrane resulting in deposition of the film on the surface of the at least one first filter membrane. In this regard, to obtain the graphene film, the exfoliated stabilized graphene solution is filtered. Optionally, the first volume lies in a range of 5 ml to 15 ml. For example, the first volume may lie in a range of 5 ml to 10 ml, 5 ml to 13 ml, 5 ml to 15 ml, 7 ml to 10 ml, 7 ml to 13 ml, 7 ml to 15 ml, 13 ml to 15 ml. Optionally, the first thickness of the graphene film depends upon the first volume of the exfoliated stabilized graphene solution. As an example, large first volume of the exfoliated stabilized graphene solution results in more first thickness of the graphene film. Optionally, the process of filtration is performed using vacuum filtration. Optionally, the exfoliated stabilized graphene solution is passed through the at least one first filter membrane by evacuating air below the first filter membrane. The process of vacuum filtration provides a force on the exfoliated stabilized graphene solution in addition to gravity and/or increases the rate of filtration. Advantageously, the technical effect of filtering the exfoliated stabilized graphene solution is that the graphene film of desired first thickness is obtained with ease.

Optionally, the method further comprising transferring the film obtained on the first surface to a second surface. Optionally, the second surface is a surface of a substrate. Optionally, the substrate is at least one of: cellulose acetate, low density polyethylene (LDPE), Polyethylene Terephthalate (PET), Polydimethylsiloxane (PDMS). Optionally, the substrate may comprise Polyethylene (PE), polyvinyl alcohol (PVA), Poly(methyl methacrylate) (PMMA), Polypropylene (PP), Polyhydroxyalkanoate (PHA), Polybutylene succinate (PBS), Polylactic acid (PLA), Polybutylene terephthalate (PBT). Alternatively, the graphene film is transferred on a paper surface. Optionally, the graphene film is transferred using a weight pressure method. Optionally, the graphene film is transferred to the second surface by at least one of: spraying, dip-coating, rod-coating. Advantageously, the graphene film is transferred to the second surface for subsequent analysis and/or characterization.

A fourth aspect of the present invention provides a method of manufacturing a film comprising graphene oxide, the method comprising:
diluting graphite oxide paste in deionized (DI) water for obtaining a graphene oxide solution;
sonicating the graphene oxide solution for a second time duration for preparing an exfoliated graphene oxide solution; and
filtering the exfoliated graphene oxide solution for obtaining the graphene oxide film of a second thickness on a third surface, wherein the film has a second thickness in a range of 0.5 μm to 20 μm, and wherein the graphene oxide film comprises at least one layer of the graphene oxide.

In this regard, a required amount of the graphite oxide paste is mixed in a required amount of the DI water to dilute the graphite oxide paste. The required amount of the graphite oxide paste could lie in a range of 1 gm to 20 gm. The required amount of the graphite oxide paste lies in a range of 1 gm to 5 gm, 1 gm to 10 gm, 1 gm to 15 gm, 1 gm to 18 gm, 1 gm to 20 gm, 4 gm to 10 gm, 4 gm to 15 gm, 4 gm to 18 gm, 4 gm to 20 gm, 8 gm to 15 gm, 8 gm to 18 gm, 8 gm to 20 gm, 13 gm to 18 gm, 13 gm to 20 gm. Optionally, the required amount of the DI water could lie in a range of 500 ml to 2000 ml. The required amount of the DI water lies in a range of 500 ml to 900 ml, 500 ml to 1300 ml, 500 ml to 1700 ml, 500 ml to 2000 ml, 700 ml to 1300 ml, 700 ml to 1700 ml, 700 ml to 2000 ml, 1000 ml to 1300 ml, 1000 ml to 1700 ml, 1000 ml to 2000 ml, 1300 ml to 1700 ml, 1300 ml to 2000 ml. Optionally, a concentration of the graphene oxide solution lies in a range of 0.5 mg/ml to 2 mg/ml.

Optionally, the method further comprises synthesizing the graphite oxide paste from natural graphite. Optionally, the step of synthesizing the graphite oxide paste from the natural graphite is performed using a modified Hummer's method Optionally, in the modified Hummer's method, 3 gm of graphite powder is pre-oxidized with 360 ml of concentrated sulfuric acid (H₂SO₄) along-with 90 ml nitric acid (HNO₃). A mixture obtained in previous step is stirred in an ice bath for the time period of 4 hours to 16 hours. The time period lies in a range of 4 hours to 7 hours, 4 hours to 12 hours, 4 hours to 16 hours, 8 hours to 12 hours, 8 hours to 16 hours, 11 hours to 16 hours. Approximately, 18 gm of Potassium Permanganate (KMnO₄) is added slowly into the mixture with an interval of 10 minutes and again stirred for 1 hour. Again, the mixture is heated up to 50 degrees Celsius for 12 hours while stirring. Further, approximately, 400 ml of ice-cold water with 3 ml of 30% Hydrogen peroxide (H₂O₂) is added to stop the reaction. The mixture is washed with 200 ml of 5 percent Hydrochloric acid (HCl) solution and allowed to settle down for approximately 2 days. In order to remove all the impurities, the mixture is centrifuged at 5000 rpm for 4 hours and the supernatant is decanted away. The remaining solid material is washed in succession with 200 ml distilled water and 200 ml ethanol several times and repeatedly centrifuged at 5000 rotations per minute (rpm) for 45 to 120 minutes. For each centrifuge, the supernatant was decanted away. After washing, the mixture was preserved in the paste form. Optionally, the natural graphite is purified by at least one of: comminution, froth flotation, reverse flotation, electrostatic separation, air classification, leaching. Optionally, the natural graphite is purified to achieve a high carbon content and remove impurities. Advantageously, utilization of the graphite oxide paste result in a homogeneous graphene oxide solution which results in uniform and/or ordered graphene oxide films.

Next, the graphene oxide solution is sonicated for the second time duration. Optionally, the second time duration lies in a range of 10 hours-20 hours. The second time duration lies in a range of 10 hours to 13 hours, 10 hours to 17 hours, 10 hours to 19 hours, 10 hours to 20 hours, 12 hours to 17 hours, 12 hours to 19 hours, 12 hours to 20 hours, 15 hours to 17 hours, 15 hours to 19 hours, 15 hours to 20 hours. Optionally, the step of sonication is performed to exfoliate the graphene oxide solution. Optionally, the step of sonication is performed using a sonicator at the room temperature. Optionally, after sonication, the exfoliated graphene oxide solution is centrifuged at a required speed to store the graphene oxide for subsequent use. Optionally, the required speed lies in a range of 4000 rpm to 8000 rpm. The required speed lies in a range of 4000 rpm to 5500 rpm, 4000 to 7000 rpm, 4000 to 8000 rpm, 4500 to 5500 rpm, 4500 to 7000 rpm, 4500 to 8000 rpm, 5500 rpm, 7500 rpm, 5500 rpm to 8000 rpm, 7000 rpm to 8000 rpm. As an example, the exfoliated graphene oxide solution may be centrifuged at a speed of 8000 rpm.

Post sonication, the exfoliated graphene oxide solution is filtered to obtain the graphene oxide film. Optionally, the step of filtering the exfoliated graphene oxide solution is performed using at least one second filter membrane, the third surface being a surface of the at least one second filter membrane, wherein the second volume of the exfoliated graphene oxide solution is passed through the at least one second filter membrane resulting in deposition of the film on the surface of the at least one second filter membrane. In this regard, optionally, the second volume lies in a range of 5 ml to 20 ml. the second volume lies in a range of 5 ml to 8 ml, 5 ml to 11 ml, 5 ml to 13 ml, 5 ml to 15 ml, 7 ml to 11 ml, 7 ml to 13 ml, 7 ml to 15 ml, 10 ml to 13 ml, 10 ml to 15 ml. optionally, the second volume impacts the second thickness of the graphene oxide layer. For example, large second volume of the exfoliated graphene oxide solution more is the second thickness of the graphene oxide layer. Optionally, the process of filtration is performed using vacuum filtration. Optionally, the exfoliated graphene oxide solution is passed through the at least one second filter membrane by evacuating air below the second filter membrane. The process of vacuum filtration provides a force on the exfoliated graphene oxide solution in addition to gravity and/or increases the rate of filtration.

Optionally, a given filter membrane is implemented as one of: a polyamide membrane, a poly(vinylidene fluoride) High Pressure Low Volume (HPLV) membrane. In this regard, the given filter membrane is the first filter membrane and/or the second filter membrane. Optionally, the given filter membrane has a pore size lying in a range of 0.2 μm to 0.45 μm. In an example, the pore size of the given filter membrane may be 0.2 μm.

Optionally, the method further comprises transferring the film obtained on the third surface to a fourth surface of a substrate for obtaining a graphene oxide encapsulated substrate. Optionally, the substrate is at least one of: cellulose acetate, low density polyethylene (LDPE), Polyethylene Terephthalate (PET), Polydimethylsiloxane (PDMS). Optionally, the substrate may comprise Polyethylene (PE), polyvinyl alcohol (PVA), Poly(methyl methacrylate) (PMMA), Polypropylene (PP), Polyhydroxyalkanoate (PHA), Polybutylene succinate (PBS), Polylactic acid (PLA), Polybutylene terephthalate (PBT). Optionally, the graphene oxide film is transferred to the fourth surface of the substrate by a least one of: at least one of: spraying, dip-coating, rod-coating. Notably, the graphene oxide film encapsulates the fourth surface of the substrate. Advantageously, the graphene oxide film is transferred to the fourth surface for subsequent analysis and/or characterization.

Optionally, the method further comprises reducing the film deposited on the graphene oxide encapsulated substrate by one of:
immersing the graphene oxide encapsulated substrate in an acidic aqueous solution having a specific concentration at a first temperature for a third time duration;
exposing the graphene oxide encapsulated substrate to acidic vapor at a second temperature for a fourth time duration.

In this regard, the acidic aqueous solution could be at least one of: ascorbic acid, citric acid, caffeic acid. As an example, the acidic aqueous solution may be ascorbic acid aqueous solution. Optionally, the specific concentration of the acidic aqueous solution is 20 millimolar (mM) to 200 mM. The specific concentration of the acidic aqueous solution lies in a range of 20 mM to 80 mM, 20 mM to 130 mM, 20 mM to 170 mM, 20 mM to 200 mM, 50 mM to 130 mM, 50 mM to 170 mM, 50 mM to 200 mM, 90 mM to 130 mM, 90 mM to 170 mM, 90 mM to 200 mM, 140 mM to 170 mM, 140 mM to 200 mM. As an example, the specific concentration of the acidic aqueous solution may be 20 mM. Optionally, the graphene oxide encapsulated substrate is immersed in the acidic aqueous solution using at least one of a machine with a robotic arm, a robot, hands of a person. Optionally, the first temperature lies in a range of 45 degrees Celsius to 95 degrees Celsius. The first temperature lies in a range of 45 degrees Celsius to 60 degrees Celsius, 45 degrees Celsius to 80 degrees Celsius, 45 degrees Celsius to 95 degrees Celsius, 50 degrees Celsius to 80 degrees Celsius, 50 degrees Celsius to 95 degrees Celsius, 70 degrees Celsius to 95 degrees Celsius. As an example, the first temperature of the ascorbic acid aqueous solution may be 90 degrees Celsius. Optionally, the third time duration lies in a range of 45 minutes to 4 hours. The third time duration lies in a range of 45 minutes to 60 minutes, 45 minutes to 160 minutes, 45 minutes to 200 minutes, 45 minutes to 4 hours, 60 minutes to 160 minutes, 60 minutes to 200 minutes, 1 hour to 4 hours, 100 minutes to 200 minutes, 100 minutes to 4 hours, 150 minutes to 200 minutes, 150 minutes to 240 minutes. As an example, the third time duration may be four hours. Immersion of the graphene oxide film may result in loss of the oxygen containing functional groups from the graphene oxide film. Optionally, reduction of the graphene oxide film is indicated by a change in colour of the graphene oxide film from light brown to black.

Optionally, the acidic vapour is hydroiodic acid vapour. Optionally, the second temperature lies in a range of 70 degrees Celsius to 110 degrees Celsius. The second temperature lies in a range of 70 degrees Celsius to 80 degrees Celsius, 70 degrees Celsius to 100 degrees Celsius, 70 degrees Celsius to 110 degrees Celsius, 75 degrees Celsius to 100 degrees Celsius, 75 degrees Celsius to 110 degrees Celsius, 90 degrees Celsius to 110 degrees Celsius. As an example, the second temperature may be 90 degrees Celsius. Optionally, the fourth time duration lies in a range of 5 minutes to 60 minutes. The fourth time duration lies in a range of 5 minutes to 15 minutes, 5 minutes to 35 minutes, 5 minutes to 50 minutes, 5 minutes to 60 minutes, 10 minutes to 35 minutes, 10 minutes to 50 minutes, 10 minutes to 60 minutes, 20 minutes to 50 minutes, 20 minutes to 60 minutes, 40 minutes to 60 minutes. As an example, the fourth time duration may be 30 minutes. Advantageously, the technical effect of reducing the graphene oxide film results in enhanced barrier properties of the graphene oxide film against the fluids.

Throughout the description and claims of this specification, the words “comprise” and “contain” and variations of the words, for example “comprising” and “comprises”, mean “including but not limited to”, and do not exclude other components, integers or steps. Moreover, the singular encompasses the plural unless the context otherwise requires; in particular, where the indefinite article is used, the specification is to be understood as contemplating plurality as well as singularity, unless the context requires otherwise.

Preferred features of each aspect of the invention may be as described in connection with any of the other aspects. Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the following diagrams wherein:

FIG. 1A is a schematic illustration of a multi-layer packaging comprising a film comprising graphene, in accordance with an embodiment of the present invention;

FIG. 1B is a schematic illustration of a multi-layer packaging comprising a film comprising graphene oxide, in accordance with another embodiment of the present invention;

FIG. 2 is a flow chart of steps of a method for manufacturing a film comprising graphene, in accordance with an embodiment of the present invention;

FIG. 3 is a flow chart of steps of a method for manufacturing a film comprising graphene oxide, in accordance with an embodiment of the present invention; and

FIG. 4 is a flow chart of steps of a method for manufacturing a multi-layer packaging, in accordance with an embodiment of the present invention.

### DETAILED DESCRIPTION

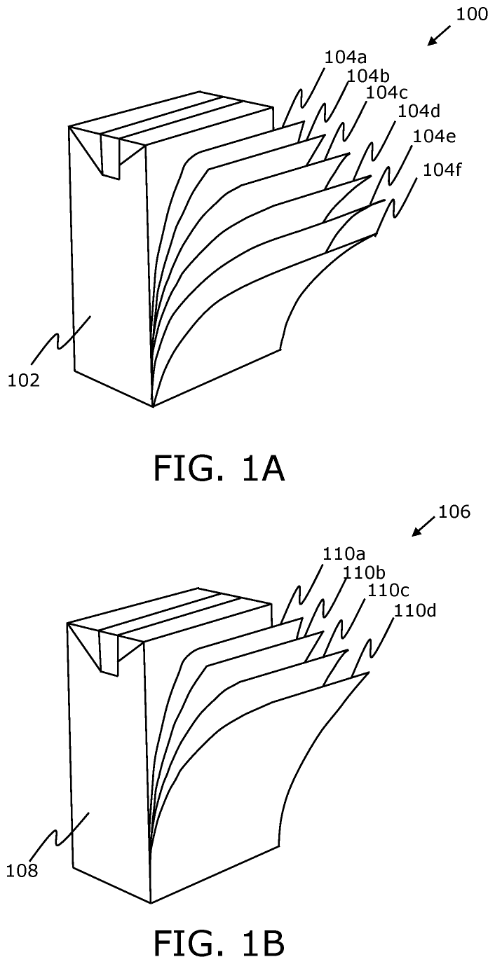

Referring to FIG. 1A, illustrated is a schematic illustration of a multi-layer packaging (depicted for example as a multi-layer packaging 100 of a tetra pack 102) comprising a film comprising graphene, in accordance with an embodiment of the present invention. The multi-layer packaging 100 has a plurality of layers (depicted for example as layers 104a, 104b, 104c, 104d, 104e, 104f). One or more layers (for example, the layer 104d) amongst the plurality of layers 104a-f comprises the film comprising the graphene.

Referring to FIG. 1B, illustrated is a schematic illustration of a multi-layer packaging (depicted for example as a multi-layer packaging 106 of a tetra pack 108) comprising a film comprising graphene oxide, in accordance with another embodiment of the present invention. The multi-layer packaging 106 has a plurality of layers (depicted for example as layers 110a, 110b, 110c, 110d). One or more layers (for example, the layer 110c) amongst the plurality of layers 110a-d comprises the film comprising the graphene oxide.

FIG. 1A and FIG. 1B are merely examples, which should not unduly limit the scope of the claims herein. A person skilled in the art will recognize many variations, alternatives, and modifications of embodiments of the present disclosure.

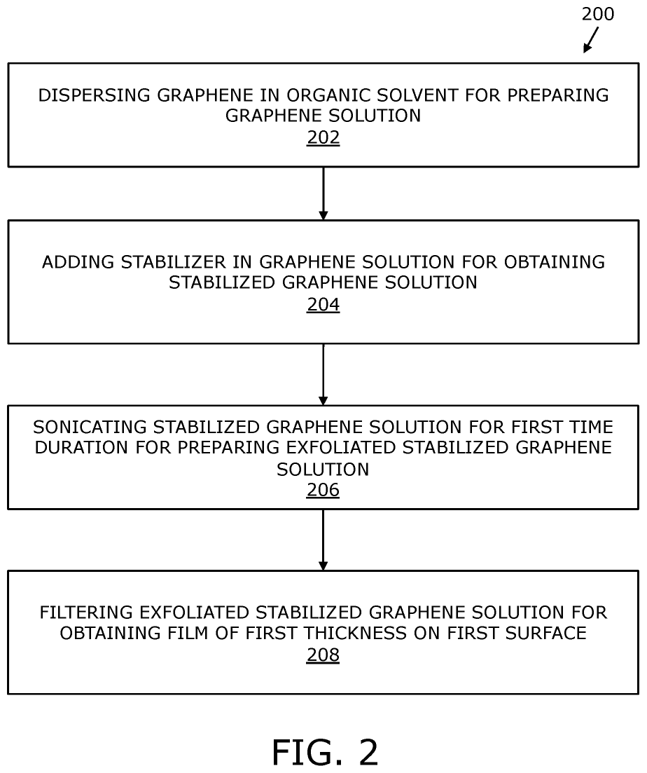

Referring to FIG. 2, illustrated is a flow chart of steps of a method 200 for manufacturing a film comprising graphene, in accordance with an embodiment of the present invention. At step 202, the graphene is dispersed in an organic solvent for preparing a graphene solution. At step 204, a stabilizer is added in the graphene solution for obtaining a stabilized graphene solution. At step 206, the stabilized graphene solution is sonicated for a first time duration for preparing an exfoliated stabilized graphene solution. At step 208, the exfoliated stabilized graphene solution is filtered for obtaining the film on a first surface. The film has a first thickness in a range of 0.5 μm to 10 μm, and the film comprises at least one layer of the graphene.

The aforementioned steps are only illustrative, and other alternatives can also be provided where one or more steps are added, one or more steps are removed, or one or more steps are provided in a different sequence without departing from the scope of the claims herein.

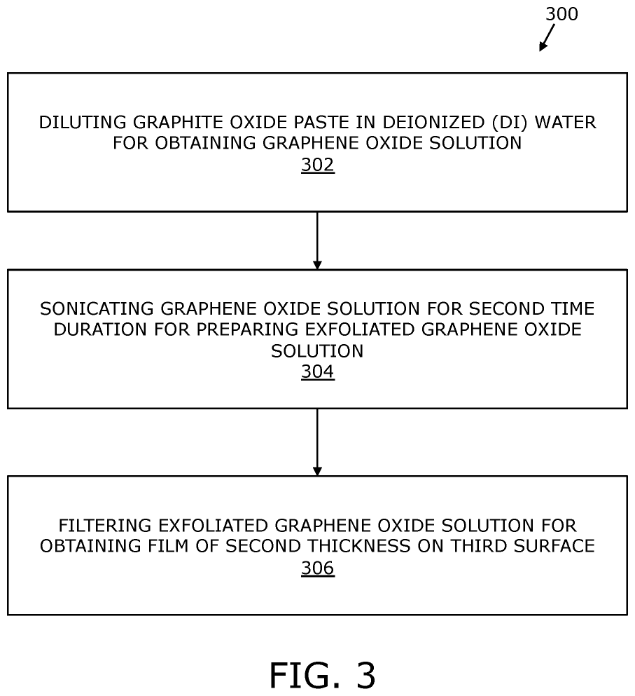

Referring to FIG. 3, illustrated is a flow chart of steps of a method 300 for manufacturing a film comprising graphene oxide, in accordance with an embodiment of the present invention. At step 302, graphite oxide paste is diluted in deionized (DI) water for obtaining a graphene oxide solution. At step 304, the graphene oxide solution is sonicated for a second time duration for preparing an exfoliated graphene oxide solution. At step 306, the exfoliated graphene oxide solution is filtered for obtaining the film on a third surface. The film has a second thickness in a range of 0.5 μm to 20 μm, and the film comprises at least one layer of the graphene oxide

The aforementioned steps are only illustrative, and other alternatives can also be provided where one or more steps are added, one or more steps are removed, or one or more steps are provided in a different sequence without departing from the scope of the claims herein.

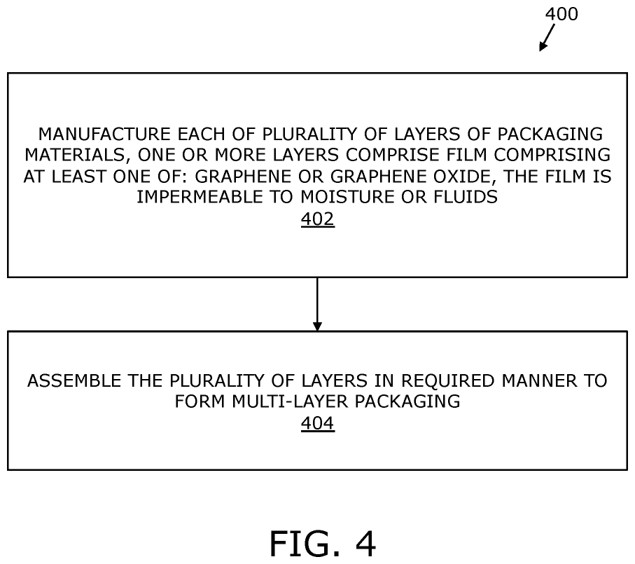

Referring to FIG. 4, illustrated is a flow chart of steps of a method 400 for manufacturing a multi-layer packaging, in accordance with an embodiment of the present invention. At step 402, each of a plurality of layers of packaging materials that constitute the multi-layer packaging are manufactured, wherein one or more layers amongst the plurality of layers comprise a film comprising at least one of: graphene or graphene oxide, and wherein the film is impermeable to moisture or fluids. At step 404, the plurality of layers is assembled in a required manner to form the multi-layer packaging.

The aforementioned steps are only illustrative, and other alternatives can also be provided where one or more steps are added, one or more steps are removed, or one or more steps are provided in a different sequence without departing from the scope of the claims herein.

1.-15. (canceled)

16.-23. (canceled)

24. A multi-layer packaging comprising a plurality of layers of packaging materials, wherein one or more layers amongst the plurality of layers comprise a film comprising graphene oxide, and wherein the film has a thickness in a range of 0.5 um to 20 um, and wherein the film is impermeable to moisture or fluids.

25. A multi-layer packaging according to claim 24, wherein the film comprising graphene oxide imparts self-recyclable properties to the multi-layer packaging.

26. A multi-layer packaging according to claim 24, wherein the film comprising graphene oxide is a graphene oxide encapsulated substrate.

27. A method of manufacturing a multi-layer packaging, the method comprising:
diluting graphite oxide paste in deionized (DI) water for obtaining a graphene oxide solution;
sonicating the graphene oxide solution for a time duration for preparing an exfoliated graphene oxide solution;
filtering the exfoliated graphene oxide solution for obtaining a film comprising graphene oxide, wherein the film has a thickness in a range of 0.5 μm to 20 μm;
manufacturing each of a plurality of layers of packaging materials that constitute the multi-layer packaging, wherein one or more layers amongst the plurality of layers comprise the film, and wherein the film is impermeable to moisture or fluids; and
assembling the plurality of layers in a required manner to form the multi-layer packaging.

28. A method according to claim 27, wherein the step of filtering the exfoliated graphene oxide solution is performed using at least one filter membrane having a surface for obtaining the film, wherein a volume of the exfoliated graphene oxide solution is passed through the at least one filter membrane resulting in deposition of the film on the surface of the at least one filter membrane.

29. A method according to claim 27, the method further comprising synthesizing the graphite oxide paste from natural graphite.

30. A method according to claim 27, the method further comprising transferring the film obtained on the surface to another surface of a substrate for obtaining a graphene oxide encapsulated substrate.

31. A method according to claim 27, the method further comprising reducing the film deposited on the graphene oxide encapsulated substrate by one of:
immersing the graphene oxide encapsulated substrate in an acidic aqueous solution having a specific concentration at a first temperature for another time duration;
exposing the graphene oxide encapsulated substrate to acidic vapour at a second temperature for further time duration.
